(19) United States
(12) Patent Application Publication
(10) Pub. No.: US 2026/0321273 A1
(43) Pub. Date: Oct. 15, 2026

(54) LAGGED FILTER UPDATE FOR ROBUST ADAPTIVE PROCESSING

(71) Applicant: Synaptics Incorporated, San Jose, CA (US)

(72) Inventors: Saeed Mosayyebpour Kaskari, Irvine, CA (US); Alireza Masnadi-Shirazi, Irvine, CA (US); Adoram Erell, Herzliya (IL)

(73) Assignee: Synaptics Incorporated, San Jose, CA (US)

(21) Appl. No.: 19/174,745

(22) Filed: Apr. 9, 2025

(51) Int. Cl. G10L 21/0224; G10L 25/84

(52) U.S. Cl. CPC G10L 21/0224; G10L 25/84

(57) ABSTRACT

A method, device, and system for audio signal processing is related updating filter parameters for a filter for adaptive online processing based on supervision of Voice Activity Detection (VAD), which may be delayed in the detection of the onset of speech in the audio signal. Multiple versions of the filter parameters are stored including lagged filter parameters, which are older than current filter parameters. When speech is detected in the audio signal by the VAD, the filter is updated with the lagged filter parameters, which are older than the delay in the detection of the onset of speech to ensure the filter is updated with filter parameters generated during noise frames. When speech is not detected in the audio signal, the filter is updated with the current filter parameters. The lagged filter parameters and current filter parameters are periodically updated when no speech is detected in the audio signal.

### TECHNICAL FIELD

The present implementations relate generally to audio signal processing, and specifically to techniques for updating filter parameters for adaptive online processing of audio signals.

### BACKGROUND OF RELATED ART

Many hands-free communication devices include microphones configured to convert sound waves into audio signals that can be transmitted, over a communications channel, to a receiving device. The audio signals often include a speech component (such as from a user of the communication device) and a noise component (such as from a reverberant enclosure). Adaptive processing techniques are often used to for speech and noise estimation, used, for example, to suppress the noise component of the received audio signals without distorting the speech component.

Parameters used by adaptive online processing systems are updated in real time, often relying on Voice Activity Detection (VAD) modules for supervision. Inaccuracies in the VAD, however, especially during speech onset detection, can lead to suboptimal updates. For example, the detection of the onset of speech by the VAD may be delayed, e.g., by 10-100 ms, thereby missing the correct onset of speech. Until the onset of speech is detected, parameters may be improperly updated using audio signals that contain speech, thereby adversely affecting the performance of the adaptive online processing systems. Accordingly, improved techniques are desirable to improve the reliability of parameter updates to provide a more robust framework for adaptive online processing.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method of speech enhancement. The method includes receiving a series of frames of an audio signal and generating filter parameters for the audio signal in each frame of the series of frames. The method may further include periodically storing the filter parameters as current filter parameters and lagged filter parameters, wherein the lagged filter parameters are generated from frames in the series of frames that precede frames in which the current filter parameters are generated. The method may include determining speech is present in a frame of the audio signal, and updating a filter for the audio signal with the lagged filter parameters in the frame in which speech is detected.

Another innovative aspect of the subject matter of this disclosure can be implemented in a speech enhancement system, including a processing system and a memory. The memory stores instructions that, when executed by the processing system, cause the speech enhancement system to receive a series of frames of an audio signal and generate filter parameters for the audio signal in each frame of the series of frames. The speech enhancement system may be further caused to periodically store the filter parameters as current filter parameters and lagged filter parameters, wherein the lagged filter parameters are generated from frames in the series of frames that precede frames in which the current filter parameters are generated. The speech enhancement system may be further caused to determine speech is present in a frame of the audio signal, and update a filter for the audio signal with the lagged filter parameters in the frame in which speech is detected.

### BRIEF DESCRIPTION OF THE DRAWINGS

The present implementations are illustrated by way of example and are not intended to be limited by the figures of the accompanying drawings.

FIG. 1 shows an example audio receiver that is configured to support lagged filter parameter updates.

FIG. 2 shows a block diagram of an example speech enhancement system that utilizes lagged filter parameter updates, according to some implementations.

FIG. 3 shows a block diagram of an example lag controller that stored multiple versions of the filter parameters and updates the linear filter using lagged filter parameters when speech is detected, according to some implementations.

FIG. 4 is a flowchart illustrating one example of the operation of the lag controller, according to some implementations.

FIG. 5 shows another block diagram of an example speech enhancement system, according to some implementations.

FIG. 6 shows an illustrative flowchart depicting an example operation for processing audio signals, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As described above, adaptive online processing for speech and noise estimation uses filter parameters that are updated in real time, often relying on Voice Activity Detection (VAD) modules for supervision. For example, often the filter parameters need to be updated when there is no speech in the audio signal, e.g., during the noise frames. Inaccuracies in the VAD, especially during speech onset detection, can lead to suboptimal updates. For example, the detection of the onset of speech by the VAD may be delayed, e.g., by 10-100 ms, thereby missing the correct onset of speech. During the delay period, e.g., before the onset of speech is correctly detected by the VAD, the filter parameters are incorrectly updated using an audio signal that includes speech data. As a result, the adaptive online processing system may behave incorrectly, e.g., improperly attenuating speech due to the filter parameter being corrupted with speech. Aspects of the present disclosure address this challenge by implementing a lagged update mechanism that stores multiple copies of parameter estimates, allowing for controlled delays in parameter updates. The proposed approach improves the reliability and accuracy of various adaptive online processing systems that utilize parameter updates when there is no speech in the audio signal, e.g., during the noise frames. The proposed approach provides a more robust framework for adaptive online processing across various applications.

Various aspects relate generally to audio signal processing, and more particularly, to storing multiple copies of filter parameters, including an older version of the filter parameters, referred to herein as lagged filter parameters, and more recent versions of the filter parameters, referred to herein as current filter parameters. Additionally, the most recent version of the filter parameters, referred to herein as newest filter parameters, may be stored. The various versions of the filter parameters are periodically updated when no speech is detected in the audio signal. The periodic update rate for the filter parameters is selected to be at least as long as the delay in the VAD for detecting the onset of speech in the audio signal. Accordingly, when the VAD indicates the detection of the onset of speech in the audio signal, the filter in the adaptive online processing system is updated using the lagged filter parameters, which are older than the onset of speech delay in the VAD and, therefore, were generated when there was no speech in the audio signal, e.g., during the noise frames. As a result, the filter in the adaptive online processing system is updated with filter parameters that have not been corrupted with speech, enabling the filter to operate properly, e.g., without attenuating speech.

As used herein, the term “filter parameter” refers to any parameter that is updated and used in an adaptive online processing system for various audio signal processing applications. For example, the filter parameter update techniques, as discussed herein, may be used as a feature in various adaptive online processing systems in audio signal processing applications, such as beamforming filter updates, acoustic echo cancellation (AEC), noise reduction algorithms, adaptive gain control, time-varying channel equalization, speech recognition systems, energy estimation for speech and noise, dynamic range compression, adaptive filter in hearing aids, real-time audio mixing, etc. It should be understood that while the present disclosure sometimes refers to a specific audio signal processing application, such as beamforming, the present disclosure may be generally applied to any of the above or other adaptive online processing systems. Moreover, the proposed method and system discussed herein may be used in any application that uses noise suppression for the audio signal.

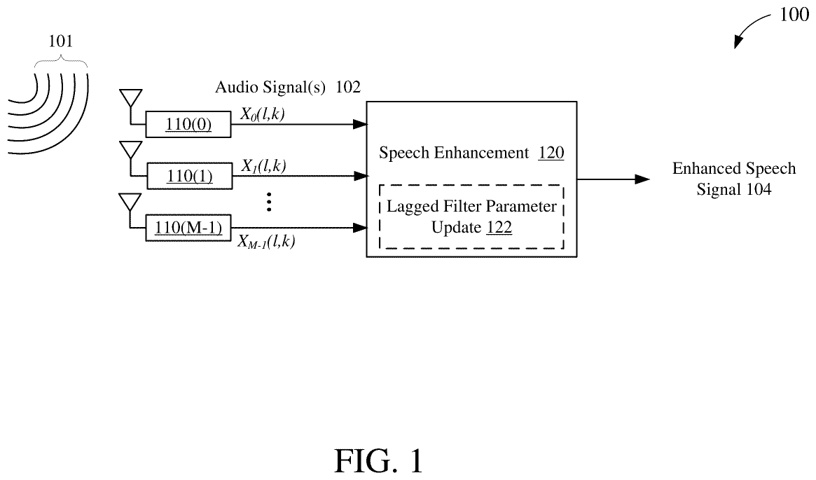

FIG. 1 shows an example audio receiver 100 that is configured to support for lagged filter parameter updates, as discussed herein. Audio receiver 100, for example, may be included in any application in which noise suppression in the audio signal is desired, including, but not limited to a headset, helmet, True Wireless Stereo (TWS) earbuds or headphones, tablet, speakerphone, monitor, television, etc.

The audio receiver 100 includes one or more microphones 110(0), 110(1), . . . 110(M−1) and a speech enhancement component 120. The audio receiver 100 may include any number M (M≥1) of microphones, which are sometimes referred to simply as microphones 110. The microphones 110 are configured to convert a series of sound waves 101 (also referred to as “acoustic waves”) into audio signals 102, represented by signals Xᵢ(l, k), i=0 . . . M−1, M≥1, where l is a frame index and k is a frequency index associated with a time-frequency domain. Thus, the audio signals 102 are electrical signals representative of the acoustic waveform.

In some implementations, the sound waves 101 may include user speech mixed with background noise or interference (such as reverberant noise from a headset enclosure). Thus, the audio signal 102 may include a speech component and a noise component.

The speech enhancement component 120 is configured to improve the quality of speech in the audio signals 102, for example, by suppressing the noise component or otherwise increasing the signal-to-noise ratio (SNR) of the audio signals 102. In some aspects, the speech enhancement component 120 may perform a linear filtering operation that attenuates the power of the noise component of the audio signals 102 to produce an enhanced speech signal 104. Thus, the enhanced speech signal 104 may have a higher SNR than the audio signals 102.

The speech enhancement component 120 includes a lagged filter parameter update component 122 that is configured to update the linear filtering operation of the speech enhancement component 120. The lagged filter parameter update component 122 stores multiple versions of the filter parameters including, for example, a current version of the filter parameters (referred to as current filter parameters) that is used for updating the filter, the most recent version of the filter parameters (referred to as newest filter parameters) and an older version of the filter parameters (referred to as lagged filter parameters). The filter parameters are generated when no speech is detected in the audio signals 102 by a VAD, and the various stored versions are periodically updated at a rate that is at least as long as the delay in the VAD for detecting the onset of speech in the audio signals 102. When the VAD indicates the detection of the onset of speech in the audio signal, the lagged filter parameter update component 122 updates the linear filtering operation of the speech enhancement component 120 using the lagged filter parameters, which are older than the onset of speech delay in the VAD and, therefore, were generated when there was no speech in the audio signal.

The linear filtering and lagged filter parameter update operations in the speech enhancement component 120, as discussed herein, may be used as a feature in various well known audio signal processing applications. For example, these operations may be used for beamforming filter updates, thereby enhancing the performance of adaptive beamforming systems by providing more reliable updates to filter weights in the presence of noise and reverberation. In another example, the operations may be used by Acoustic Echo Cancellation (AEC) to improve the stability and accuracy of the filter parameter updates in AEC systems, leading to better suppression of echo artifacts in real-time communication. In another example, the operations may be used by noise reduction systems to refine the estimates of noise characteristics over time, thereby improving overall audio quality. In another example, the operations may be used by adaptive gain control systems to manage fluctuations in audio levels more effectively, ensuring consistent output in varying environments. In another example, the operations may be used by time-varying channel equalization systems that require real-time equalization of time-varying channels, such as wireless communications, where channel conditions change rapidly. In another example, the operations may be used by speech recognition systems to enhance feature extraction and preprocessing stages, thereby improving the recognition accuracy by providing cleaner input data. In another example, the operations may be used by energy estimation for speech and noise to provide smoother and more accurate estimates of energy levels over time, benefiting applications in speech processing and environmental monitoring. In another example, the operations may be used by dynamic range compression systems to assist in adjusting parameters more smoothly in response to audio signal changes. In another example, the operations may be used by adaptive filtering in hearing aids enabling better performance in diverse acoustic environments. In another example, the operations may be used by real-time audio mixing systems where smooth parameter updates are important for maintaining audio fidelity during live performances or broadcasts. It should be understood that while the present disclosure sometimes refers to a specific audio signal processing application, such as beamforming, the linear filtering and lagged filter parameter update operations discussed herein may be generally applied to any of the above or other known adaptive online processing systems.

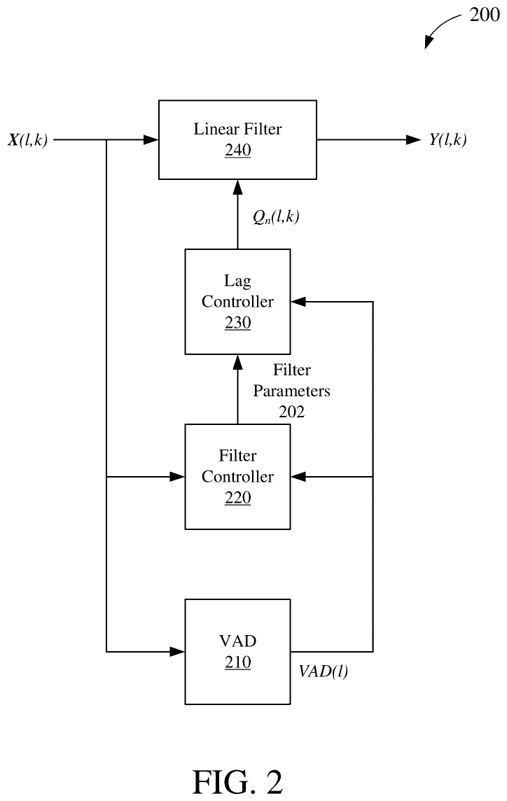

FIG. 2 shows a block diagram of an example speech enhancement system 200 that utilizes lagged filter parameter updates, according to some implementations. In some aspects, the speech enhancement system 200 may be one example of the speech enhancement component 120 of FIG. 1.

More specifically, the speech enhancement system 200 may receive a series of frames of audio signals (X(l, k)) of an input audio signal and produce a corresponding frame (Y(l, k)) of an enhanced audio signal by filtering or suppressing noise in the audio signal. With reference for example to FIG. 1, the input audio signals X(l, k) may be one example of the audio signal 102 and the enhanced audio signal Y(l, k) may be one example of the enhanced speech signal 104.

In some implementations, the speech enhancement system 200 may include a voice activity detector (VAD) 210, a filter controller 220, a lag controller 230, and a linear filter 240. The VAD 210 is configured to determine or predict whether speech is present (or absent) in the current frame of the audio signals (X(l, k)). More specifically, the VAD 210 may provide one or more parameters in the speech detection signal VAD(l) indicating whether speech is present (or absent) in the current frame l of the audio signal X(l, k). In some implementations, the VAD 210 may include a deep neural network (DNN) that is trained to infer a probability of speech (p_{speech}(l, k)) or conversely a probability of noise (pₙₒᵢₛₑ(l, k)) in the current frame of the audio signal X(l, k), based on a neural network model, where 0≤p_{speech}(l, k)≤1. The VAD 210 may generate the speech detection signal VAD(l) based on the probability of speech p_{speech}(l, k). For example, the VAD 210 may determine that speech is present in the current frame of the audio signal X(l, k) (VAD(l)=1) if the probability of speech p_{speech}(l, k), averaged across all frequency bins k, is greater than a threshold probability, and otherwise, speech is determined to be not present in the audio signal X(l, k) (VAD(l)=0). The VAD 210, however, may be delayed, e.g., by 10-100 ms, in the detection of the onset of speech in the audio signal. Accordingly, after the onset of speech, during the delay the VAD 210 may incorrectly indicate that speech is absent from the current audio frame, i.e., VAD(l)=0.

The filter controller 220 is configured to produce a set of filter parameters 202 associated with the linear filter 240 that needs to be updated based on supervision of the VAD 210. The filter parameters 202 generated by the filter controller 220, for example, may be determined based, at least, on the speech detection signal VAD(l) and the series of input audio frames X(l, k). The filter parameters 202 generated by the filter controller 220 depend on the type of filter operations performed by the linear filter 240. For example, if the linear filter 240 performs beamforming operations using a linear filter that relies on a covariance of noise that needs to be updated when VAD(l)=0 (during the noise frames), the filter parameters 202 may include a set of weights or coefficients to be implemented by the beamforming linear filter 240. As is well known in the art, other filter operations, e.g., acoustic echo cancellation (AEC), noise reduction algorithms, adaptive gain control, time-varying channel equalization, speech recognition systems, energy estimation for speech and noise, dynamic range compression, adaptive filter in hearing aids, real-time audio mixing, etc., may use other types of filter parameters, which may be produced by the filter controller 220.

The linear filter 240 may need to be updated with the filter parameters 202 when speech is absent from the current audio frame, e.g., during the noise frames, but is not updated when speech is present in the current audio frame. As noted above, the VAD 210 may be delayed, e.g., by 10-100 ms, in the detection of the onset of speech in the audio signal and accordingly, the speech detection signal VAD(l) may incorrectly indicate that speech is absent from the current audio frame which speech is in fact present.

The lag controller 230 receives the filter parameters 202 and the speech detection signal VAD(l) and is configured to store multiple versions of the filter parameters 202, where each version has a different age, i.e., the different version of the filter parameters 202 were generated in different frames l. The lag controller 230 is further configured to update the linear filter 240 with filter parameters Qₙ(l, k). When the VAD 210 indicates that speech is not detected in the audio signal, VAD(l)=0, i.e., during noise frames, the filter parameters Qₙ(l, k) provided by the lag controller 230 to update the linear filter 240 are a relatively recent version of the filter parameters. When the VAD 210 indicates that speech is detected in the audio signal, VAD(l)=1, the filter parameters Qₙ(l, k) provided by the lag controller 230 to update the linear filter 240 are a relatively older version of the filter parameters (sometimes referred to herein as lagged filter parameters). The lagged filter parameters, for example, may be a version of the filter parameters 202 generated by the filter controller 220 in a frame l that is older than the delay experienced by the VAD 210 in detecting the onset of speech. Consequently, when the VAD 210 indicates that speech is detected in the audio signal, VAD(l)=1, even though the VAD 210 may be delayed in the detection of the onset of speech, the filter parameters Qₙ(l, k) used to update the linear filter 240 were generated prior to the actual onset of speech.

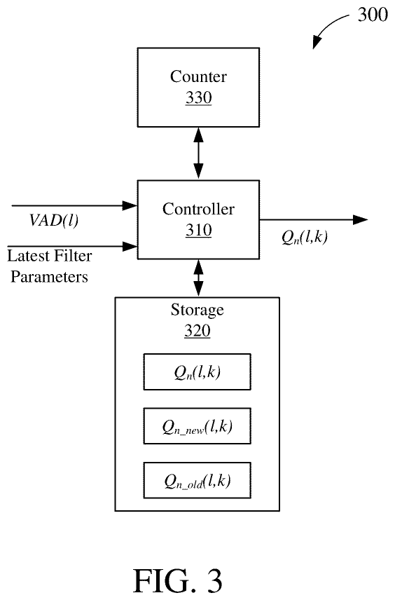

FIG. 3 shows a block diagram of an example lag controller 300 that stores multiple versions of the filter parameters and updates the linear filter using lagged filter parameters when speech is detected, according to some implementations. In some aspects, the lag controller 300 may be one example of the lag controller 230 of FIG. 2.

In some implementations, the lag controller 300 may include a controller 310, storage 320, and a counter 330 and is configured to receive the latest filter parameters, e.g., filter parameters 202 from the filter controller 220 in FIG. 2, and the speech detection signal VAD(l) and is configured to provide filter parameters Qₙ(l, k) to update a filter, such as linear filter 240 shown in FIG. 2.

The storage 320 in the lag controller 300 is configured to store multiple versions of the filter parameters 202, each version of the stored filter parameters being generated in different frames. For example, the storage 320 may store the version of the filter parameters used to currently update the linear filter 240 as current filter parameters Qₙ(l, k). The storage 320 may store a relatively older version of the filter parameters as the lagged filter parameters Q_{n_old}(l, k). The lagged filter parameters Q_{n_old}(l, k), thus, are generated in frames of the audio signal that precede the current filter parameters Qₙ(l, k). In some implementations, the storage 320 may additionally store the newest version of the filter parameters, e.g., provided in each new frame l by the filter controller 220 shown in FIG. 2, as the newest filter parameters Q_{n_new}(l, k).

The controller 310 receives the speech detection signal VAD(l) and controls the storage 320 to update the various versions of the filter parameters. The controller 310 may be configured with a predetermined lag length, e.g., a predetermined number of frames l. After the predetermined lag length, e.g., determined by counter 330, the stored versions of the filter parameters are updated when speech is not detected in the audio signal, VAD(l)=0, i.e., during noise frames. For example, when speech is not detected in a frame l, the latest filter parameters 202 provided by the filter controller 220, are stored as the newest filter parameters Q_{n_new}(l, k). At every drop point, i.e., after the predetermined lag length or predetermined number of frames, the values of the current filter parameters Qₙ(l, k) are stored as the lagged filter parameters Q_{n_old}(l, k) and the values of the newest filter parameters Q_{n_new}(l, k) are then stored in the current filter parameters Qₙ(l, k), which are output and provided to update the filter.

The controller 310 may be further configured to update the stored versions of the filter parameters when speech is detected in the audio signal, VAD(l)=1, to update current filter parameters Qₙ(l, k) with the values of the lagged filter parameters Q_{n_old}(l, k). For example, when speech is detected in a frame l, i.e., VAD 210 detects the onset of speech which may be delayed, the values of the lagged filter parameters Q_{n_old}(l, k) are then stored as the newest filter parameters Q_{n_new}(l, k) and the current filter parameters Qₙ(l, k), which are output and provided to update the filter. Accordingly, when speech is detected in the audio signal, the filter is updated with the current filter parameters Qₙ(l, k) that have the values of the lagged filter parameters Q_{n_old}(l, k), where are older than the predetermined lag length, thereby ensuring that the filter is updated with filter parameters generated during noise frames.

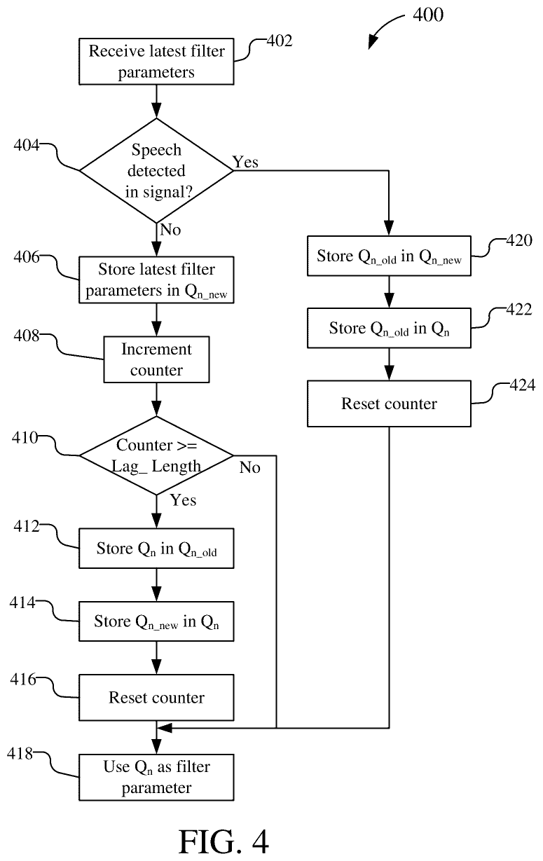

FIG. 4 is a flowchart illustrating one example of the operation 400 of the lag controller 300, according to some implementations.

As illustrated in FIG. 4, the lag controller 300 receives the latest filter parameters (402), such as filter parameters 202 from the filter controller 220 shown in FIG. 2. The lag controller 300, for example, may receive the latest filter parameters for every new frame l. If no speech is detected in the audio signal (404), e.g., the speech detection signal VAD(l)=0, the lag controller 300 updates one or more versions of the stored filter parameters. For example, the latest filter parameters are stored in storage 320 as newest filter parameters Q_{n_new}(l, k) (406) and the counter 330 is incremented (408). If the counter 330 is equal to or greater than the lag length (410), e.g., the predetermined number of frames, that is at least as long as the delay experienced by the VAD in detecting the onset of speech, then the current filter parameters Qₙ(l, k) are stored as the lagged filter parameters Q_{n_old}(l, k) (412) and the values of the newest filter parameters Q_{n_new}(l, k) are then stored in the current filter parameters Qₙ(l, k) (414), the counter 330 is reset (416), and the current filter parameters Qₙ(l, k) are used to update the filter (418). On the other hand, if the counter 330 is not equal to or greater than the lag length (410), e.g., the predetermined number of frames, then the operation 400 skips the updates in (412) and (414) and the counter reset in (416) and uses simply uses the values of the current filter parameters Qₙ(l, k) to update the filter (418).

On the other hand, if at (404) speech is detected in the audio signal, e.g., the speech detection signal VAD(l)=1, then the lagged filter parameters Q_{n_old}(l, k) are stored in the newest filter parameters Q_{n_new}(l, k) (420) and the current filter parameters Qₙ(l, k), the lagged filter parameters Q_{n_old}(l, k) are stored in the current filter parameters Qₙ(l, k) (422), and the current filter parameters Qₙ(l, k), the counter 330 is reset (424), and the current filter parameters Qₙ(l, k) are used to update the filter (418).

An example of the operation of the lag controller 300 is further illustrated by the pseudo-code in Table 1.

TABLE 1

```
if (VAD == 0)
  {
    counter++;
    if (counter >=Lag_length)
    {
      Qₙ_{_{—}}_{old} ←Qₙ
      Qₙ ←Qₙ_{_{—}}_{new}
      counter = 0;
    }
  }
  else if (VAD == 1)
  {
    Qₙ_{_{—}}_{new} ←Qₙ_{_{—}}_{old}
    Qₙ ←Qₙ_{_{—}}_{old}
    counter = 0;
  }
  →Filter uses Qₙ
```

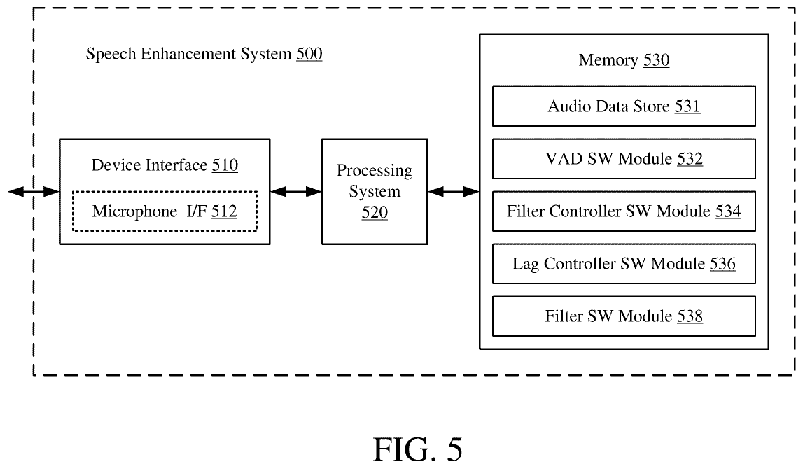

FIG. 5 shows another block diagram of an example speech enhancement system 500, according to some implementations. More specifically, the speech enhancement system 500 is configured to provide lagged filter parameters generated during noise frames to a linear filter, when the onset of speech is detected in the audio signal, as discussed herein. In some implementations, the speech enhancement system 500 may be one example of the speech enhancement component 120 of FIG. 1. The speech enhancement system 500 includes a device interface 510, a processing system 520, and a memory 530.

The device interface 510 is configured to communicate with one or more components of an audio receiver (such as one or more microphones 110(0), 110(1), . . . 110(M−1) of FIG. 1). In some implementations, the device interface 510 may include a microphone interface (I/F) 512 configured to receive audio signals via the one or more microphones.

The memory 530 may include an audio data store 531 configured to store frames of the audio signal as well as any intermediate signals that may be produced by the speech enhancement system 500 as a result of speech enhancement operation. The memory 530 also may include a non-transitory computer-readable medium (including one or more nonvolatile memory elements, such as EPROM, EEPROM, Flash memory, or a hard drive, among other examples) that may store at least the following software (SW) modules:
a VAD SW module 532 to determine a VAD parameter based at least in part on the audio signals, where the VAD parameter indicates whether speech is present or absent in an audio signal frame;
a filter controller SW module 534 to generate filter parameters based on the audio signal for a filter that needs to be updated based on supervision of the VAD;
a lag controller SW module 536 to store multiple versions of the filter parameters, each version having a different age, and to provide lagged filter parameters to the filter when speech is detected in the audio signal by the VAD; and
a filter SW module 538 to filter a noise component of the audio signal to enhance the speech component in the audio signal, based at least in part on the updated filter parameters.

Each software module includes instructions that, when executed by the processing system 520, causes the speech enhancement system 500 to perform the corresponding functions.

The processing system 520 may include any suitable one or more processors capable of executing scripts or instructions of one or more software programs stored in the speech enhancement system 500 (such as in the memory 530). For example, the processing system 520 may execute the VAD SW module 532 to determine a VAD parameter based at least in part on the audio signals, where the VAD parameter indicates whether speech is present or absent in an audio signal frame. The processing system 520 also may execute the filter controller SW module 534 to generate filter parameters based on the audio signal for a filter that needs to be updated based on supervision of the VAD. The processing system 520 also may execute the lag controller SW module 536 to store multiple versions of the filter parameters, each version having a different age, and to provide lagged filter parameters to the filter when speech is detected in the audio signal by the VAD. The processing system 520 also may execute the filter SW module 538 to filter a noise component of the audio signal to enhance the speech component in the audio signal, based at least in part on the updated filter parameters.

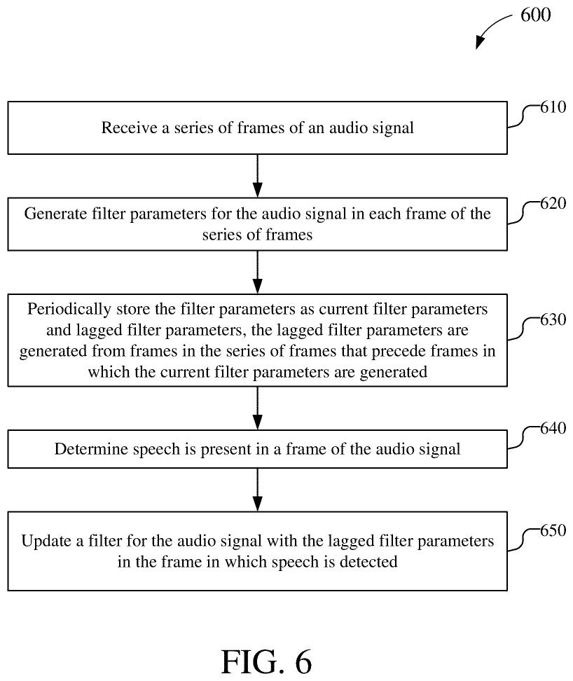

FIG. 6 shows an illustrative flowchart depicting an example operation 600 for processing audio signals, according to some implementations. In some implementations, the example operation 600 may be performed by a speech enhancement system such as the speech enhancement component 120 of FIG. 1 or the speech enhancement system 200 of FIG. 2.

The speech enhancement system receives a series of frames of an audio signal (610), e.g., illustrated by audio signals Xᵢ(k, l), i=0 . . . . M−1, M≥1, from microphones 110(0), 110(1), . . . 110(M−1) received by the speech enhancement component 120 shown in FIG. 1 or audio signals (X(l, k)) received by the speech enhancement system 200, respectively.

The speech enhancement system generates filter parameters for the audio signal in each frame of the series of frames (620), e.g., as discussed in relation to filter controller 220 shown in FIG. 2.

The speech enhancement system periodically stores the filter parameters as current filter parameters and lagged filter parameters, where the lagged filter parameters are generated from frames in the series of frames that precede frames in which the current filter parameters are generated (630), e.g., as discussed in relation to lag controller 230 shown in FIG. 2 or the lag controller 300 shown in FIG. 3.

The speech enhancement system detects speech in a frame of the audio signal (640), e.g., as discussed in relation to VAD 210 shown in FIG. 2. In some implementations, voice activity detection (VAD) determines whether speech is present in each frame in the series of frames.

The speech enhancement system updates a filter for the audio signal with the lagged filter parameters in the frame in which speech is detected (650), e.g., as discussed in relation to the lag controller 230 and linear filter 240 shown in FIG. 2, and the lag controller 300 shown in FIG. 3.

In some implementations, the lagged filter parameters are used by the filter in subsequent frames of the audio signal until speech is not detected in the audio signal, e.g., as discussed in relation to the lag controller 230 and linear filter 240 shown in FIG. 2, and the lag controller 300 shown in FIG. 3.

In some implementations, the speech enhancement system may determine speech is not present in a subsequent frame in the audio signal, and the speech enhancement system may update the filter in the subsequent frame with the current filter parameters, e.g., as discussed in relation to the lag controller 230 and linear filter 240 shown in FIG. 2, and the lag controller 300 shown in FIG. 3. For example, in some implementations, the current filter parameters are used by the filter until speech is determined to be present in the audio signal.

In some implementations, the speech enhancement system may determine speech is not present in a subsequent frame in the series of frames, and the speech enhancement system may periodically update both the lagged filter parameters and the current filter parameters after a predetermined number of frames, where the lagged filter parameters are updated with values of the current filter parameters and the current filter parameters are updated with values of new filter parameters, e.g., as discussed in relation to the lag controller 230 and linear filter 240 shown in FIG. 2, and the lag controller 300 shown in FIG. 3.

In some implementations, the speech enhancement system may further store the filter parameters generated for the audio signal as new filter parameters in each frame, e.g., as discussed in relation to the lag controller 230 and linear filter 240 shown in FIG. 2, and the lag controller 300 shown in FIG. 3. For example, in some implementations, when speech is determined present in the frame in the series of frames, the speech enhancement system may update the new filter parameters with values of the lagged filter parameters and update the current filter parameters with values of the lagged filter parameters.

In some implementations, the filter for the audio signal may be a filter for at least one of beamforming, acoustic echo cancellation, noise reduction, adaptive gain control, time-varying channel equalization, speech recognition, energy estimate for speech and noise, dynamic range compression, adaptive filter in hearing aids, real-time audio mixing.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of speech enhancement, comprising:
receiving a series of frames of an audio signal;
generating filter parameters for the audio signal in each frame of the series of frames;
periodically storing the filter parameters as current filter parameters and lagged filter parameters, wherein the lagged filter parameters are generated from frames in the series of frames that precede frames in which the current filter parameters are generated;
determining speech is present in a frame of the audio signal; and
updating a filter for the audio signal with the lagged filter parameters in the frame in which speech is detected.

2. The method of claim 1, wherein the lagged filter parameters are used by the filter in subsequent frames of the audio signal until speech is determined to not be present in the audio signal.

3. The method of claim 1, further comprising:
determining speech is not present in a subsequent frame in the series of frames; and
updating the filter in the subsequent frame with the current filter parameters.

4. The method of claim 3, wherein the current filter parameters are used by the filter until speech is determined to be present in the audio signal.

5. The method of claim 1, further comprising:
determining speech is not present in a subsequent frame in the series of frames; and
periodically updating both the lagged filter parameters and the current filter parameters after a predetermined number of frames, wherein the lagged filter parameters are updated with values of the current filter parameters and the current filter parameters are updated with values of new filter parameters.

6. The method of claim 1, further comprising storing the filter parameters generated for the audio signal as new filter parameters in each frame.

7. The method of claim 6, wherein when speech is determined present in the frame in the series of frames, the method further comprises:
updating the new filter parameters with values of the lagged filter parameters and updating the current filter parameters with values of the lagged filter parameters.

8. The method of claim 1, wherein voice activity detection (VAD) determines whether speech is present in each frame in the series of frames.

9. The method of claim 1, wherein the filter for the audio signal performs filtering for at least one of a beamforming, acoustic echo cancellation, noise reduction, adaptive gain control, time-varying channel equalization, speech recognition, energy estimate for speech and noise, dynamic range compression, adaptive filter in hearing aids, real-time audio mixing.

10. A speech enhancement system configured, comprising:
a processing system; and
a memory storing instructions that, when executed by the processing system, causes the speech enhancement system to:
receive a series of frames of an audio signal;
generate filter parameters for the audio signal in each frame of the series of frames;
periodically store the filter parameters as current filter parameters and lagged filter parameters, wherein the lagged filter parameters are generated from frames in the series of frames that precede frames in which the current filter parameters are generated;
determine speech is present in a frame of the audio signal; and
update a filter for the audio signal with the lagged filter parameters in the frame in which speech is detected.

11. The speech enhancement system of claim 10, wherein the lagged filter parameters are used by the filter in subsequent frames of the audio signal until speech is determined to not be present in the audio signal.

12. The speech enhancement system of claim 10, wherein the speech enhancement system is further caused to:
determine speech is not present in a subsequent frame in the series of frames; and
update the filter in the subsequent frame with the current filter parameters.

13. The speech enhancement system of claim 12, wherein the current filter parameters are used by the filter until speech is determined to be present in the audio signal.

14. The speech enhancement system of claim 10, wherein the speech enhancement system is further caused to:
determine speech is not present in a subsequent frame in the series of frames; and
periodically update both the lagged filter parameters and the current filter parameters after a predetermined number of frames, wherein the lagged filter parameters are updated with values of the current filter parameters and the current filter parameters are updated with values of new filter parameters.

15. The speech enhancement system of claim 10, wherein the speech enhancement system is further caused to store the filter parameters generated for the audio signal as new filter parameters in each frame.

16. The speech enhancement system of claim 15, wherein when speech is determined present in the frame in the series of frames, the speech enhancement system is further caused to:
update the new filter parameters with values of the lagged filter parameters and update the current filter parameters with values of the lagged filter parameters.

17. The speech enhancement system of claim 10, wherein voice activity detection (VAD) determines whether speech is present in each frame in the series of frames.

18. The speech enhancement system of claim 10, wherein the filter for the audio signal performs filtering for at least one of a beamforming, acoustic echo cancellation, noise reduction, adaptive gain control, time-varying channel equalization, speech recognition, energy estimate for speech and noise, dynamic range compression, adaptive filter in hearing aids, real-time audio mixing.
